(19) United States
(12) Patent Application Publication
(10) Pub. No.: US 2006/0261514 A1
(43) Pub. Date: Nov. 23, 2006

(54) Method for the production of golf ball

(75) Inventors: Masatoshi Yokota, Kobe-shi (JP); Seiichiro Endo, Kobe-shi (JP); Haruki Shinagawa, Kobe-shi (JP)

Correspondence Address: BIRCH STEWART KOLASCH & BIRCH, PO BOX 747, FALLS CHURCH, VA, 22040-0747, US

(73) Assignee: SRI Sports Limited

(21) Appl. No.: 11/413,172

(22) Filed: Apr. 28, 2006

(30) Foreign Application Priority Data
May 17, 2005 (JP) 2005-143393

(51) Int. Cl. B29C 47/00; A63B 39/00; B29C 65/00; B32B 37/04; B32B 37/10

(52) U.S. Cl. 264/248; 156/146; 156/228; 156/245; 156/292; 156/304.2; 425/408

(57) ABSTRACT

A mold 18 has a metal main body 32, 38, a plated layer 34, 40 overlaid on this main body 32, 38, and a fluorine-contained resin-coated layer 36, 42 overlaid on this plated layer 34, 40. The plated layer 34, 40 is formed by an electroless nickel plating treatment. The surface of the plated layer 34, 40 is roughened by a chemical treatment. The fluorine-contained resin-coated layer 36, 42 is formed by baking. The fluorine-contained resin-coated layer 36, 42 includes polytetrafluoroethylene. A resin composition including a thermoplastic polyurethane elastomer is compressed and heated in this mold, thereby giving a half shell. The half shell is readily released from the mold 18. A core, and two pieces of the half shell fitted to this core are subjected to compression molding to give a golf ball.

This application claims priority on Patent Application No. 2005-143393 filed in JAPAN on May 17, 2005, the entire contents of which are hereby incorporated by reference.

### BACKGROUND OF THE INVENTION

1. Field of the Invention

The present invention relates to methods for the production of golf balls. More particularly, the present invention relates to improvement of mold for use in forming half shells.

2. Description of the Related Art

General golf balls have a core and a cover. The cover comprises a thermoplastic resin composition. The cover is formed by injection molding or compression molding.

The injection molding is excellent in mass production capability. In the injection molding, the core is first retained at the center of a spherical cavity by a retaining pin. Next, a molten thermoplastic resin composition is injected into a gap between the cavity face and the core. Because the retaining pin shifts backward in a final stage of the injection, the core may migrate from the center, concurrent with the flow of the resin composition. The migration results in unevenness in the thickness of the cover (generally referred to as “uneven thickness”). The air which is present in the gap between the cavity face and the core is discharged from a bent hole or a clearance of the retaining pin in accordance with the influx of the resin composition. When this discharge is insufficient, defective appearance due to the residual air occurs. Accordingly, difficulties are involved in the production of a high quality golf ball by the injection molding.

In the compression molding, a half shell composed of a thermoplastic resin composition is used. In forming the half shell, a mold composed of an upper mold half having a protruding part and a lower mold half having a recessed part is used. The resin composition placed in the mold flows upon compression and heating, and fills in the cavity formed between the protruding part and the recessed part. After cooling the resin composition, the mold is released to remove the half shell.

In formation of the cover by compression molding, two pieces of the half shell, and a core covered by these half shells are placed in other mold. By clamping this mold, the resin composition is compressed, and the excess resin composition outflows from the parting line. The air which is present between the core and the half shell is discharged from the parting line concomitant with the outflow of the resin composition. The resin composition remaining in the mold is solidified to give a cover. Process for such compression molding is disclosed in US2004/0232590A1 (JP-A No. 2004-344386).

When the release performance is insufficient, in removing the half shell, the half shell is dragged which shall be accompanied by deformation. Use of a deformed half shell may result in formation of an uneven cover. In recent years, golf balls having a thin cover have been developed, and been available in the market. In this type of golf ball, a thin half shell is used. Deformation is apt to be caused in the thin half shell when it is removed from a mold. Recently, golf balls having a cover comprising a soft material such as polyurethane elastomer have been developed, and been available in the market. In this type of golf ball, a half shell comprising a soft material is used. Deformation is apt to be caused in this type of half shell when it is removed from a mold. Release performance of the mold for half shells is very important.

Various types of molds having a release agent layer on the surface thereof have been proposed. However, according to any of such molds, sufficient release performance is not achieved. In particular, no release agent that is excellent in the release performance for polyurethane elastomers has been found. In addition, any release agent layer is inferior in durability. Repeated use greatly reduces the release performance. Insufficient release performance may deteriorate the quality of the golf ball.

An object of the present invention is to provide a mold for golf balls which is excellent in the release performance, with the excellent release performance being long-lasting. Other object of the present invention is to provide a method of production which enables obtaining superior golf balls.

### SUMMARY OF THE INVENTION

In the method of the production of a golf ball according to the present invention, a mold having a metal main body, a plated layer which was overlaid on this main body and has a surface roughened with a chemical treatment, and a fluorine-contained resin-coated layer which was overlaid on this plated layer is used.

This method of the production comprises:

(1) a step of obtaining a bowl-shaped half shell by compression and heating of a thermoplastic resin composition with the aforementioned mold,

(2) a step of placing a core, and two pieces of the half shell fitted to the core in other mold comprising an upper mold half and a lower mold half having a hemispherical cavity face and having numerous pimples on the surface thereof, in the state of this mold being released,

(3) a step of clamping this mold to allow the thermoplastic resin composition of the half shell to be compressed in the spherical cavity while being heated, thereby discharging excessive thermoplastic resin composition from the spherical cavity, and

(4) a step of forming a cover by hardening the thermoplastic resin composition remaining in the spherical cavity.

Preferably, the plated layer is formed by an electroless nickel plating treatment. The fluorine-contained resin-coated layer may be formed by baking. Preferably, the surface of the main body is roughened. Preferably, the fluorine-contained resin-coated layer comprises polytetrafluoroethylene.

This mold is suited for formation of the half shell comprising a polyurethane elastomer as a principal component of the base polymer in the thermoplastic resin composition. This mold is suited for formation of the half shell for golf balls with a cover having a thickness of 0.1 mm or greater and 0.8 mm or less. This mold is suited for formation of the half shell for golf balls with a cover having an A hardness of 70 or greater and 98 or less.

The mold according to the present invention is excellent in the release performance, with the excellent release performance being long-lasting. According to this mold, deformation of the half shell is suppressed. According to the method of the production in which this mold is used, golf balls that are excellent in the quality can be obtained.

### BRIEF DESCRIPTION OF THE DRAWINGS

FIG. 1 is a partially cut off cross-sectional view illustrating a golf ball obtained by the method of the production according to one embodiment of the present invention;

FIG. 2 is a cross-sectional view illustrating a part of the first mold for use in the production of the golf ball shown in FIG. 1;

FIG. 3 is an enlarged cross-sectional view illustrating a part of the first mold shown in FIG. 2; and

FIG. 4 is a cross-sectional view illustrating a part of the second mold for use in the production of the golf ball shown in FIG. 1.

### DESCRIPTION OF THE PREFERRED EMBODIMENTS

The present invention is hereinafter described in detail with appropriate references to the accompanying drawing according to the preferred embodiments.

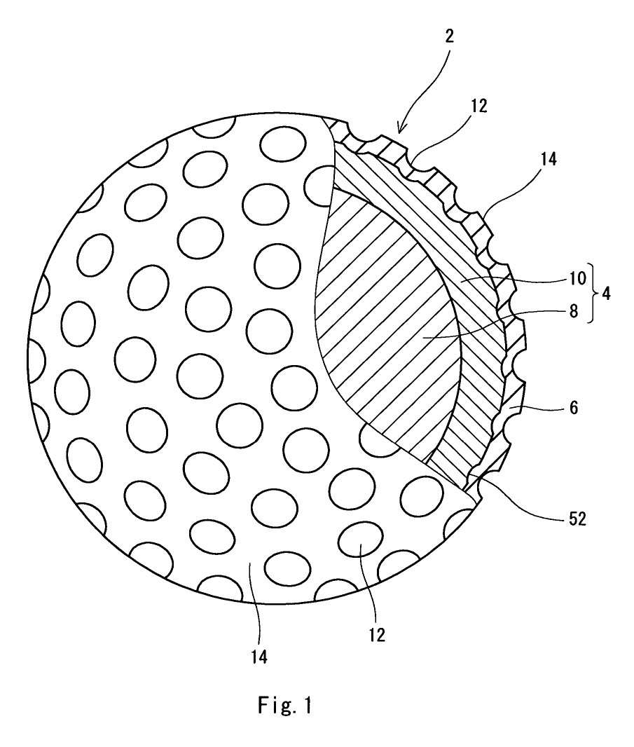

A golf ball 2 depicted in FIG. 1 has a spherical core 4, and a cover 6 covering this core 4. The core 4 includes a spherical center 8, and a mid layer 10 covering this center 8. Numerous dimples 12 are formed on the surface of the cover 6. Of the surface of the cover 6, a part except for the dimples 12 is a land 14. Although this golf ball 2 has a paint layer and a mark layer to the external side of the cover 6, these layers are not shown in the Figure.

This golf ball 2 has a diameter of from 40 mm to 45 mm. From the standpoint of conformity to a rule defined by United States Golf Association (USGA), the diameter is preferably equal to or greater than 42.67 mm. In light of suppression of the air resistance, the diameter is preferably equal to or less than 44 mm, and more preferably equal to or less than 42.80 mm. Weight of this golf ball 2 is 40 g or greater and 50 g or less. In light of attainment of great inertia, the weight is preferably equal to or greater than 44 g, and more preferably equal to or greater than 45.00 g. From the standpoint of conformity to a rule defined by USGA, the weight is preferably equal to or less than 45.93 g.

The center 8 is obtained through crosslinking of a rubber composition. Illustrative examples of the base rubber for use in the rubber composition include polybutadienes, polyisoprenes, styrene-butadiene copolymers, ethylene-propylene-diene copolymers and natural rubbers. Two or more kinds of the rubbers may be used in combination. In light of the resilience performance, polybutadienes are preferred, and particularly, high cis-polybutadienes are preferred.

For crosslinking of the center 8, a co-crosslinking agent is usually used. Preferable co-crosslinking agent in light of the resilience performance may be zinc acrylate, magnesium acrylate, zinc methacrylate and magnesium methacrylate. Into the rubber composition, an organic peroxide may be preferably blended together with the co-crosslinking agent. Examples of suitable organic peroxide include dicumyl peroxide, 1,1-bis(t-butylperoxy)-3,3,5-trimethylcyclohexane, 2,5-dimethyl-2,5-di(t-butylperoxy)hexane and di-t-butyl peroxide.

Various kinds of additives such as a filler, a sulfur compound, an anti-aging agent, a coloring agent, a plasticizer, a dispersant and the like may be blended in an adequate amount to the rubber composition as needed. Into the rubber composition may be also blended crosslinked rubber powder or synthetic resin powder.

The center 8 has a diameter of equal to or greater than 30.0 mm, and particularly equal to or greater than 35.0 mm. The center 8 has a diameter of equal to or less than 41.5 mm, and particularly equal to or less than 41.0 mm. The center 8 may be subjected to a surface treatment such as grinding, brushing, flaming, a plasma treatment or the like. The center 8 may be composed of two or more layers. Other layer comprising a thermoplastic resin composition may be also provided between the center 8 and the mid layer 10.

The mid layer 10 comprises a thermoplastic resin composition. Illustrative examples of the base polymer for use in this resin composition include ionomer resins, thermoplastic polyester elastomers, thermoplastic polyamide elastomers, thermoplastic polyurethane elastomers, thermoplastic polyolefin elastomers and thermoplastic polystyrene elastomers. In particular, an ionomer resin is preferred. Ionomer resins are highly elastic. As described later, this golf ball 2 has a very thin cover 6. Upon impacts of this golf ball 2 with a driver, the mid layer 10 is greatly deformed. The mid layer 10 in which an ionomer resin is used is responsible for the flight performance upon shots with a driver. When other resin is used in combination with an ionomer resin, the ionomer resin is included as a principal component of the base polymer, in light of the flight performance. Proportion of the ionomer resin occupying in the total base polymer is preferably equal to or greater than 50% by weight, more preferably equal to or greater than 70% by weight, and particularly preferably equal to or greater than 85% by weight.

Examples of preferable ionomer resin include binary copolymers of α-olefin with an α,β-unsaturated carboxylic acid having 3 to 8 carbon atoms. Examples of preferable other ionomer resin include ternary copolymers of α-olefin, an α,β-unsaturated carboxylic acid having 3 to 8 carbon atoms, and an α,β-unsaturated carboxylate ester having 2 to 22 carbon atoms. In the binary copolymer and the ternary copolymer, examples of preferable α-olefin include ethylene and propylene, while examples of preferable α,β-unsaturated carboxylic acid include acrylic acid and methacrylic acid. In the binary copolymer and the ternary copolymer, a part of the carboxyl group is neutralized with a metal ion. Illustrative examples of the metal ion for use in the neutralization include sodium ion, potassium ion, lithium ion, zinc ion, calcium ion, magnesium ion, aluminum ion and neodymium ion. The neutralization may also be carried out with two or more kinds of the metal ions. In light of the resilience performance and durability of the golf ball 2, examples of particularly suitable metal ion include sodium ion, zinc ion, lithium ion and magnesium ion.

Preferable binary copolymer includes 80% by weight or more and 90% by weight or less α-olefin, and 10% by weight or more and 20% by weight or less α,β-unsaturated carboxylic acid. This binary copolymer is excellent in the resilience performance. Preferable ternary copolymer includes 70% by weight or more and 85% by weight or less α-olefin, 5% by weight or more and 30% by weight or less α,β-unsaturated carboxylic acid, and 1% by weight or more and 25% by weight or less α,β-unsaturated carboxylate ester. This ternary copolymer is excellent in the resilience performance. Particularly preferred ionomer resin is a copolymer of ethylene, and acrylic acid or methacrylic acid.

Specific examples of the ionomer resin include trade names “Himilan 1555”, “Himilan 1557”, “Himilan 1605”, “Himilan 1706”, “Himilan 1707”, “Himilan AM7311”, “Himilan AM7315”, “Himilan AM7317”, “Himilan AM7318” and “Himilan MK7320”, available from Du Pont-MITSUI POLYCHEMICALS Co., Ltd.; trade names “Surlyn® 7930”, “Surlyn® 7940”, “Surlyn® 8140”, “Surlyn® 8940”, “Surlyn® 8945”, “Surlyn® 9120”, “Surlyn® 9910” and “Surlyn® 9945”, available from Dupont; and trade names “IOTEK 7010”, “IOTEK 7030”, “IOTEK 8000” and “IOTEK 8030”, available from EXXON Corporation. Two or more kinds of the ionomer resin may be used in combination. An ionomer resin neutralized with a monovalent metal ion, and an ionomer resin neutralized with a bivalent metal ion may be also used in combination.

In light of the flight performance, the mid layer 10 has a thickness of preferably equal to or greater than 0.3 mm, more preferably equal to or greater than 0.5 mm, and particularly preferably equal to or greater than 0.7 mm. In light of the feel at impact, the thickness is preferably equal to or less than 2.5 mm, and more preferably equal to or less than 2.0 mm.

In light of adhesion between the mid layer 10 and the cover 6, the mid layer 10 is preferably subjected to a surface treatment to increase the roughness thereof. Specific examples of the surface treatment include brushing, grinding and the like. A reinforcing layer maybe also provided between the mid layer 10 and the cover 6 for the purpose of enhancing adhesion between both layers.

The cover 6 comprises a thermoplastic resin composition. Illustrative examples of the base polymer of this resin composition include thermoplastic polyurethane elastomers, thermoplastic polyester elastomers, thermoplastic polyamide elastomers, thermoplastic polyolefin elastomers, thermoplastic polystyrene elastomers and ionomer resins. It is preferred that a thermoplastic polyurethane elastomer is used as the base polymer. The thermoplastic polyurethane elastomers are soft. Great spin rate is achieved when the golf ball 2 having a cover 6 comprising a thermoplastic polyurethane elastomer is hit with a short iron. The cover 6 comprising a thermoplastic polyurethane elastomer is responsible for the control performance upon a shot with a short iron. The thermoplastic polyurethane elastomer is also responsible for the scuff resistance of the cover 6.

The thermoplastic polyurethane elastomer includes a polyurethane component as a hard segment, and a polyester component or a polyether component as a soft segment. Illustrative examples of the curing agent for the polyurethane component include alicyclic diisocyanates, aromatic diisocyanates and aliphatic diisocyanates. In particular, alicyclic diisocyanate is preferred. Because the alicyclic diisocyanate has no double bond in the main chain, yellowing of the cover 6 can be suppressed. Additionally, because the alicyclic diisocyanate is excellent in strength, the cover 6 can be prevented from being scuffed. Two or more kinds of diisocyanates may be used in combination.

Illustrative examples of the alicyclic diisocyanate include 4,4′-dicyclohexylmethane diisocyanate (H₁₂MDI), 1,3-bis(isocyanatomethyl)cyclohexane (H₆XDI), isophorone diisocyanate (IPDI) and trans-1,4-cyclohexane diisocyanate (CHDI). In light of versatility and processability, H₁₂MDI is preferred.

Illustrative examples of the aromatic diisocyanate include 4,4′-diphenylmethane diisocyanate (MDI) and toluene diisocyanate (TDI). Illustrative examples of the aliphatic diisocyanate include hexamethylene diisocyanate (HDI).

Specific examples of the thermoplastic polyurethane elastomer include trade name “Elastollan XNY90A”, trade name “Elastollan XNY97A”, trade name “Elastollan XNY585” and trade name “Elastollan XKP016N”, available from BASF Japan Ltd; and trade name “Rezamin P4585LS” and trade name “Rezamin PS62490”, available from Dainichiseika Color & Chemicals Mfg. Co., Ltd.

When other resin is used in combination with the thermoplastic polyurethane elastomer in the cover 6, the thermoplastic polyurethane elastomer is included in the base polymer as a principal component, in light of the control performance. Proportion of the thermoplastic polyurethane elastomer occupying in the total base polymer is preferably equal to or greater than 50% by weight, more preferably equal to or greater than 70% by weight, and particularly preferably equal to or greater than 85% by weight.

Into the cover 6 may be blended a coloring agent such as titanium dioxide, a filler such as barium sulfate, a dispersant, an antioxidant, an ultraviolet absorbent, a light stabilizer, a fluorescent agent, a fluorescent brightening agent and the like in an appropriate amount as needed. Also, the cover 6 may be blended with powder of a highly dense metal such as tungsten, molybdenum or the like for the purpose of adjusting the specific gravity.

It is preferred that the cover 6 has a hardness as measured with a JIS-A type hardness scale of equal to or less than 98. This cover 6 is soft. This cover 6 is responsible for the feel at impact and control performance. In this respect, the hardness is more preferably equal to or less than 97. The hardness is preferably equal to or greater than 70. The cover 6 having the hardness of equal to or greater than 70 does not greatly deteriorate the resilience performance of the golf ball 2. In this respect, the hardness is more preferably equal to or greater than 75. For the measurement of the hardness, a sheet which had been formed by hot press is used having a thickness of about 2 mm and consisting of the same material as the cover 6. Prior to the measurement, the sheet is stored at a temperature of 23° C. for two weeks. When the measurement is carried out, three sheets are overlaid.

The cover 6 has a thickness of equal to or less than 0.8 mm. As described above, the cover 6 is soft. The soft cover 6 is disadvantageous in terms of the resilience coefficient of the golf ball 2. Upon shots with a driver, the mid layer 10 as well as the center 8 of the golf ball 2 is deformed greatly. By setting the thickness of the cover 6 to be equal to or less than 0.8 mm, the cover 6 does not adversely affect the resilience coefficient to a large extent upon a shot with a driver, even though the cover 6 is soft. In light of the flight performance and ease in molding, the cover 6 has a thickness of more preferably equal to or less than 0.6 mm, and particularly preferably equal to or less than 0.5 mm. In light of ease in forming the cover 6, the thickness is preferably equal to or greater than 0.1 mm, and more preferably equal to or greater than 0.2 mm.

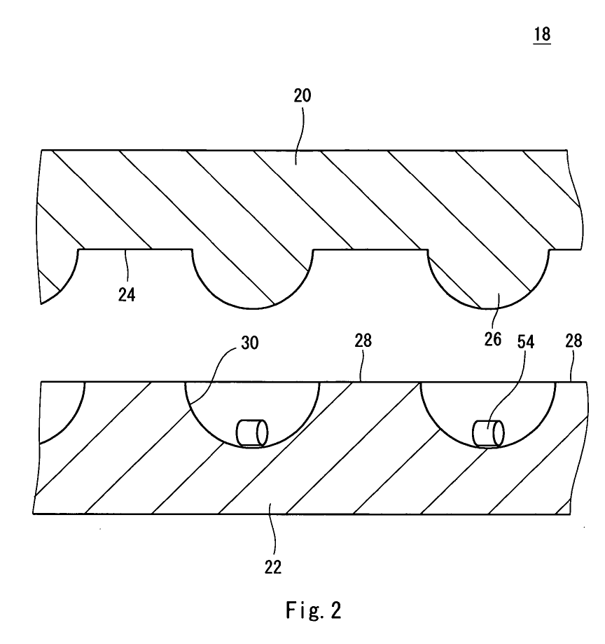

FIG. 2 is a cross sectional view illustrating a part of a first mold 18 for use in the production of the golf ball 2 shown in FIG. 1. The first mold 18 has an upper mold half 20 and a lower mold half 22. The upper mold half 20 has a flat part 24 and a protruding part 26. The surface of the protruding part 26 has a shape that is substantially hemispherical. The lower mold half 22 has a flat part 28 and a recessed part 30. The surface of the recessed part 30 has a shape that is substantially hemispherical. The protruding part 26 has a radius that is smaller than the radius of the recessed part 30. When the upper mold half 20 and the lower mold half 22 are mated, a space is formed between the protruding part 26 and the recessed part 30. When the upper mold half 20 and the lower mold half 22 are mated, a space is formed also between the flat part 24 of the upper mold half 20 and the flat part 28 of the lower mold half 22.

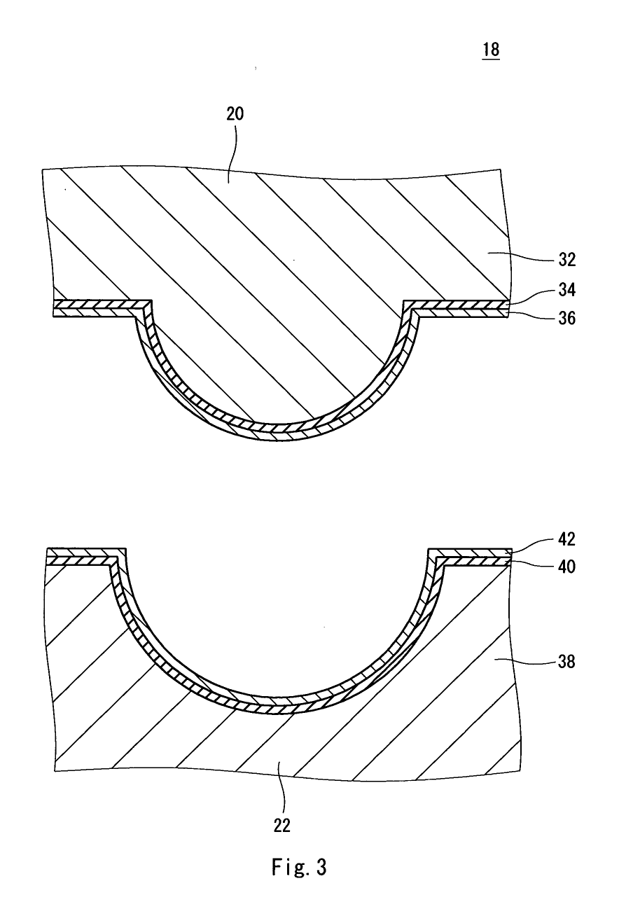

FIG. 3 is an enlarged cross-sectional view illustrating a part of the first mold 18 shown in FIG. 2. In this Figure, the upper mold half 20 and the lower mold half 22 are illustrated. The upper mold half 20 has a main body 32, a plated layer 34 and a fluorine-contained resin-coated layer 36. The lower mold half 22 also has a main body 38, a plated layer 40 and a fluorine-contained resin-coated layer 42. The plated layer 34, 40 is overlaid on the main body 32, 38. The fluorine-contained resin-coated layer 36, 42 is overlaid on the plated layer 34, 40. The main body 32, 38 comprises a metal material. Typically, the main body 32, 38 comprises steel such as carbon steel, stainless steel or the like. Preferably, the surface of the main body 32, 38 is subjected to roughening. By thus roughening, adhesion between the main body 32, 38 and the plated layer 34, 40 can be enhanced. Specific examples of the roughening treatment include blasting treatment and grinding treatment.

The plated layer 34, 40 may be formed with an electroless nickel plating treatment. The plated layer 34, 40 preferably has a thickness of 5 μm or greater and 30 μm or less. The surface of the plated layer 34, 40 may be roughened by a chemical treatment. In this chemical treatment, the surface of the plated layer 34, 40 is exposed to a chemical. By the chemical treatment, asperity is formed on the surface of the plated layer 34, 40. This asperity is finer than the asperity generated by roughening with a mechanical treatment. This plated layer is extremely discriminative as a substrate of the fluorine-contained resin-coated layer.

The fluorine-contained resin-coated layer 36, 42 has a thickness of preferably 5 μm or greater and 30 μm or less. Typically, polytetrafluoroethylene is used for the fluorine-contained resin-coated layer 36, 42. In formation of the fluorine-contained resin-coated layer 36, 42, a fluorine-contained resin is first coated on the surface of the plated layer 34, 40. Next, the temperature of the first mold 18 is elevated. In general, the first mold 18 is allowed to stand under a circumstance of about 400° C. Thus, the fluorine-contained resin is molten, which is impregnated in the fine asperity on the surface of the plated layer 34, 40. This treatment is referred to as baking. Coating of the fluorine-contained resin and the baking may be repeated twice or more times. By the impregnation, the fluorine-contained resin-coated layer 36, 42 firmly adhered to the plated layer 34, 40 can be provided. By the impregnation, sufficiently thick fluorine-contained resin-coated layer 36, 42 can be provided. This fluorine-contained resin-coated layer 36, 42 is excellent in lubricating property, nonadhesiveness and abrasion resistance. This fluorine-contained resin-coated layer 36, 42 is also excellent in durability. The surface of this first mold 18 has a Vickers hardness of 600 or greater and 1200 or less.

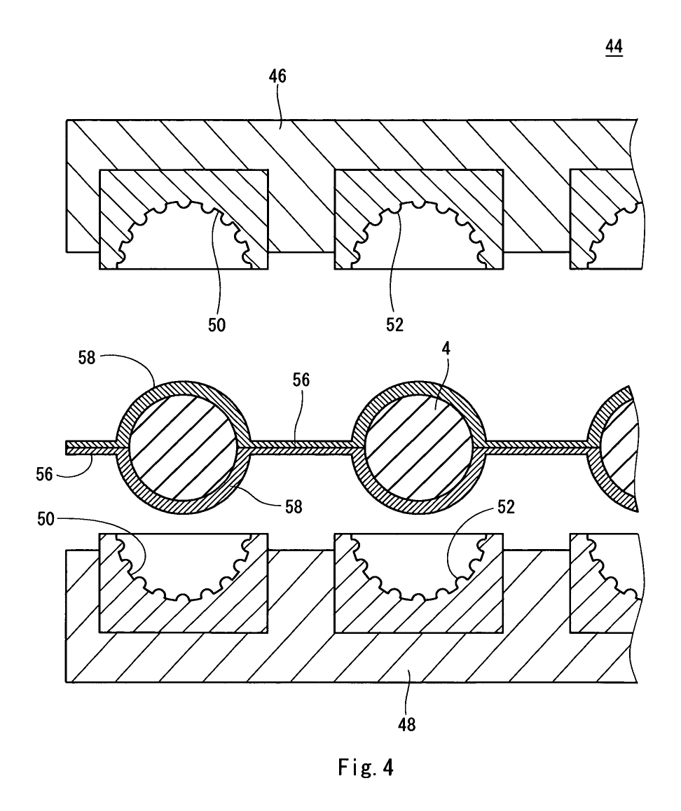

FIG. 4 is a cross sectional view illustrating a part of a second mold 44 for use in the production of the golf ball 2 shown in FIG. 1. The second mold 44 has an upper mold half 46 and a lower mold half 48. Each of the upper mold half 46 and the lower mold half 48 has numerous cavity faces 50, respectively, and hemispherical cavities are formed by these cavity faces 50. When the upper mold half 46 and the lower mold half 48 are mated, spherical cavities are formed. Numerous pimples 52 are formed on the cavity face 50.

Upon production of the golf ball 2, a base rubber, a crosslinking agent and various additives are first kneaded to give a rubber composition. Next, this rubber composition is placed into a mold having an upper mold half and a lower mold half, and having a spherical cavity (not shown in the Figure). Next, this mold is clamped. Next, the rubber composition is heated via the mold. Heating causes a crosslinking reaction of the rubber. The rubber composition is cured through crosslinking. The mold is released, and a spherical center 8 is removed.

This center 8 is placed into a mold having an upper mold half and a lower mold half, and having a spherical cavity (not shown in the Figure). A molten resin composition is injected around this center 8 according to injection molding. This resin composition is hardened to form the mid layer 10. Thus, the core 4 comprising the center 8 and the mid layer 10 is obtained. The mid layer 10 may be formed also by compression molding.

Next, a thermoplastic resin and additives are blended, and extruded from an extruder to give a resin composition. Next, this resin composition is cut into a predetermined size. By thus cutting, pellets 54 are obtained (see, FIG. 2). Next, the pellet 54 is placed into the first mold 18. As shown in FIG. 2, the pellet 54 is put on the recessed part 30 of the lower mold half 22. Next, the lower mold half 22 is relatively elevated toward the upper mold half 20, and mold clamping is carried out. The mold clamping is usually carried out with a pressing machine. According to the mold clamping, the pellet 54 is compressed, and heated. The compression and heating results in flow of the resin composition, thereby filling the space between the upper mold half 20 and the lower mold half 22 with the resin composition. Next, the first mold 18 is cooled. By cooling, temperature of the resin composition is also lowered. When the temperature is lowered enough, the first mold 18 is released to remove a preforming material 56. As shown in FIG. 4, the preforming material 56 has numerous half shells 58. The half shell 58 is bowl-shaped.

Because sufficiently thick fluorine-contained resin-coated layer 36, 42 is formed as described above, the first mold 18 is excellent in the release performance. Even though the preforming material 56 is removed, the half shell 58 is not deformed. This first mold 18 is suited for formation of the half shell 58 comprising a soft material. This first mold 18 is also suited for formation of thin half shells 58. Because the fluorine-contained resin-coated layer 36, 42 is firmly adhered to the substrate, excellent release performance is maintained even though the first mold 18 is repeatedly used.

Next, as shown in FIG. 4, the core 4 is sandwiched between two pieces of the preforming material 56. The core 4 is fitted to two pieces of the half shell 58. Next, the preforming material 56 and the core 4 are placed into the second mold 44 being released. The half shell 58 and the core 4 are usually put on the cavity face 50 of the lower mold half 48.

Next, the lower mold half 48 is relatively elevated toward the upper mold half 46, thereby allowing the lower mold half 48 to approach the upper mold half 46. This operation is usually carried out with a pressing machine. Speed of the approaching is 3.0 mm/sec or greater and 200.0 mm/sec or less. This speed is high. High speed results in achievement of a short cycle time. This step is referred to as approaching step.

The approaching step is terminated at the stage in which the distance between the upper mold half 46 and the lower mold half 48 reaches to a predetermined value. Thereafter, the lower mold half 48 is allowed to approach the upper mold half 46 at a speed of 0.5 mm/sec or greater and 2.0 mm/sec or less. The thermoplastic resin composition of the half shell 58 is heated while being compressed in the spherical cavity. The resin composition flows upon compression and heating to cover around the core 4. Excess resin composition outflows from the spherical cavity. This step is referred to as mold clamping step. In the mold clamping step, the pimples 52 push the half shell 58 and the mid layer 10. According to this pushing, the half shell 58 and the mid layer 10 are depressed. Depression of the half shell 58 results in formation of the dimples 12.

Next, pressure of the pressing machine is elevated. The resin composition of the half shell 58 is compressed in the spherical cavity at a pressure higher than the pressure in the mold clamping step. This step is referred to as high pressure step. According to the high pressure step, the upper half shell 58 and the lower half shell 58 are firmly bound. According to the high pressure step, dimples 12 are formed having a shape precisely reflecting the shape of the pimples 52.

Next, the second mold 44 is cooled in the state of the second mold 44 being clamped. By cooling, the resin composition of the half shell 58 is hardened. This resin composition constitutes the cover 6. This step is referred to as hardening step. Following the hardening, the second mold 44 is released, and the golf ball 2 is removed. Because the half shell 58 is homogenous, this golf ball 2 is excellent in the quality.

### EXAMPLES

### Example

A thermoplastic polyurethane elastomer (trade name “Elastollan XNY97A” described above) in an amount of 100 parts by weight and 4 parts by weight of titanium dioxide were kneaded in a twin screw extruder, and the resin composition was extruded. The conditions are as follows:

temperature: 230° C.;

screw diameter: 45 mm;

screw rotation speed: 200 rpm; and

L/D of screw: 35.

This resin composition was cut to give cylindrical pellets. This pellet had a diameter of 20 mm, and a weight of about 2 g.

A first mold was provided having: a main body comprising carbon steel; a plated layer formed by an electroless nickel plating treatment and subjected to a chemical treatment to roughen the surface thereof; and a fluorine-contained resin-coated layer which comprises polytetrafluoroethylene and was obtained by baking. To the recessed part of this first mold was placed the pellet. Accordingly, a preforming material having numerous half shells was obtained by compression molding. The conditions are as follows:

molding temperature: 160° C.;

compressive force in primary compression step: 7845 N;

time period of primary compression step: 2 min;

compressive force in secondary compression step: 26478 N;

time period of secondary compression step: 2 min;

compressive force in cooling step: 26478N; and

time period of cooling step: 5 min.

The compressive force is a value obtained through dividing the maximum force applied to the first mold with the pressing machine by the number of the recessed part possessed by the first mold. The force applied to the first mold with the pressing machine is a value obtained by multiplying the pressure of the ram of the pressing machine by the cross sectional area of this ram.

### Comparative Example 1

A preforming material was obtained in a similar manner to Example except that a first mold provided by coating a fluorine based release agent (trade name “DAIFREE”, available from Daikin Industries, Ltd.) on a main body comprising carbon steel was used.

### Comparative Example 2

A preforming material was obtained in a similar manner to Example except that a first mold provided by overlaying electroless nickel plating impregnated with Teflon™ (trade name “Technophos”, available from ASAHI PRECISION CO., LTD.) on a main body comprising carbon steel was used.

### Comparative Example 3

A preforming material was obtained in a similar manner to Example except that a first mold provided by coating Teflon™ on a main body comprising carbon steel was used.

[Evaluation of Release Performance]

Release performance of the preforming material from the first mold was graded according to the following criteria:

A: the preforming material can be readily picked up from the first mold;

B: some difficulty is involved in picking up the preforming material from the first mold; and

C: the preforming material can not be picked up from the first mold.

The results are shown in Table 1 below.

[Evaluation of Durability]

The preforming material was repeatedly molded, and number of times of the molding was counted until the picking up from the first mold could not be perfected. Then, grading according to the following criteria was conducted.

A: 1000 times or more;

B: 100 times or more and less than 1000 times; and

C: less than 100 times.

The results are shown in Table 1 below.

TABLE 1
Results of evaluation

| | | Compara. | Compara. | Compara. |
|---|---|---|---|---|
| | Example | Example 1 | Example 2 | Example 3 |
| Release performance | A | B | C | B |
| Durability | A | C | — | C |

As is clear from Table 1, the mold of Example exhibited favorable release performance, with the excellent release performance being long-lasting. Accordingly, advantages of the present invention are clearly indicated by these results of evaluation.

The description herein above is merely for illustrative examples, and various modifications can be made without departing from the principles of the present invention.

What is claimed is:

1. A method of the production of a golf ball which comprises the steps of:
obtaining a bowl-shaped half shell by compression and heating of a thermoplastic resin composition with a mold having a metal main body, a plated layer which was overlaid on said main body and has a surface roughened with a chemical treatment, and a fluorine-contained resin-coated layer which was overlaid on said plated layer;
placing a core, and two pieces of the half shell fitted to said core in other mold comprising an upper mold half and a lower mold half having a hemispherical cavity face and having numerous pimples on the surface thereof, in the state of said mold being released,
clamping said mold to allow the thermoplastic resin composition of the half shell to be compressed in the spherical cavity while being heated, thereby discharging excessive thermoplastic resin composition from the spherical cavity, and
forming a cover by hardening the thermoplastic resin composition remaining in the spherical cavity.

2. The method of the production according to claim 1 wherein said plated layer is formed by an electroless nickel plating treatment, and said fluorine-contained resin-coated layer is formed by baking.

3. The method of the production according to claim 1 wherein the surface of said main body is roughened.

4. The method of the production according to claim 1 wherein said fluorine-contained resin-coated layer comprises polytetrafluoroethylene.

5. The method of the production according to claim 1 wherein base polymer in said thermoplastic resin composition comprises a polyurethane elastomer as a principal component.

6. The method of the production according to claim 1 wherein said cover has a thickness of 0.1 mm or greater and 0.8 mm or less.

7. The method of the production according to claim 1 wherein said cover has a hardness as measured with a JIS-A hardness scale of 70 or greater and 98 or less.

8. A mold for a golf ball having a metal main body, a plated layer which was overlaid on said main body and has a surface roughened with a chemical treatment, and a fluorine-contained resin-coated layer which was overlaid on said plated layer.
